(19) United States
(12) Patent Application Publication
(10) Pub. No.: US 2010/0007127 A1
(43) Pub. Date: Jan. 14, 2010

(54) BUILD A BOOK

(76) Inventors: Michelle Van Etten, Valrico, FL (US); Trisha Ladouceur, Edmonton (CA)

Correspondence Address: CHARLES C.H. WU, 98 DISCOVERY, IRVINE, CA, 92618-3105, US

(21) Appl. No.: 12/171,124

(22) Filed: Jul. 10, 2008

(51) Int. Cl. B42F 5/00

(52) U.S. Cl. 281/22

(57) ABSTRACT

A method for assembling a scrapbook by selecting a set of non-traditional shaped components and assembling same into a final product is provided. The component for assembling may be displayed in either a paper media, or an electronic media.

### FIELD OF THE INVENTION

This invention generally relates to a scrapbook, and more specifically to a method and apparatus for building a non-traditional scrapbook.

### BACKGROUND

Scrapbooks are known. Traditionally a scrapbook is of a rectangular shape as shown in FIG. 1. United States published patent application No. 20020051675 to Yasuji Nomura discloses a traditional rectangular shaped scrapbook that includes a spine adapted to bind a variable plurality of binder inserts; includes a substantially rectangular and planar front cover coupled to the spine, where the front cover includes a co-planar storage area, a window in its front surface opening onto the co-planar storage area and an opening into the co-planar storage area; and includes a substantially rectangular and planar, bag-like display sheet that has a substantially transparent front wall and a back wall, and is adapted to receive contents for display therein, and is also adapted to be inserted through the opening of the front cover and into the co-planar storage area of the front cover such that the contents for display may be seen through the window and the transparent front wall.

Scrapbook covers are known. Traditionally a scrapbook cover is of a rectangular shape. U.S. design patent application No. D460482 to Yasuji Nomura discloses a traditional rectangular shaped scrapbook cover.

Due to preferences in different groups of users, there thus exists a need for an improved or non-traditional scrapbook having different shapes suitable for different users other than the traditional shaped, rectangular scrapbook.

### SUMMARY OF THE INVENTION

An improved or non-traditional scrapbook having different shapes suitable for different users other than the traditional shaped, rectangular scrapbook is provided.

A method for displaying an improved or non-traditional scrapbook having different shapes suitable for different users other than the traditional shaped, rectangular scrapbook is provided.

A method comprising step of selecting at least two non-traditional components for assembling into a scrap book is provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a traditional shaped scrapbook component.

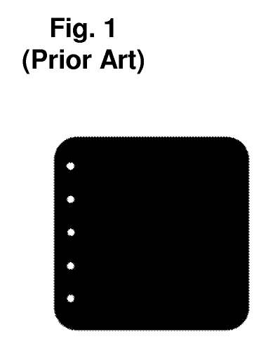

FIGS. 2A-2D illustrate a set of non-traditionally shaped preferred embodiment of the present invention, wherein substantially non-rectangular shaped scrapbook components are shown.

FIG. 3 is an exemplified flowchart in accordance with a first aspect of the present invention.

FIG. 4 is an exemplified flowchart in accordance with second aspect of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a scrapbook with components having non-traditional shapes. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

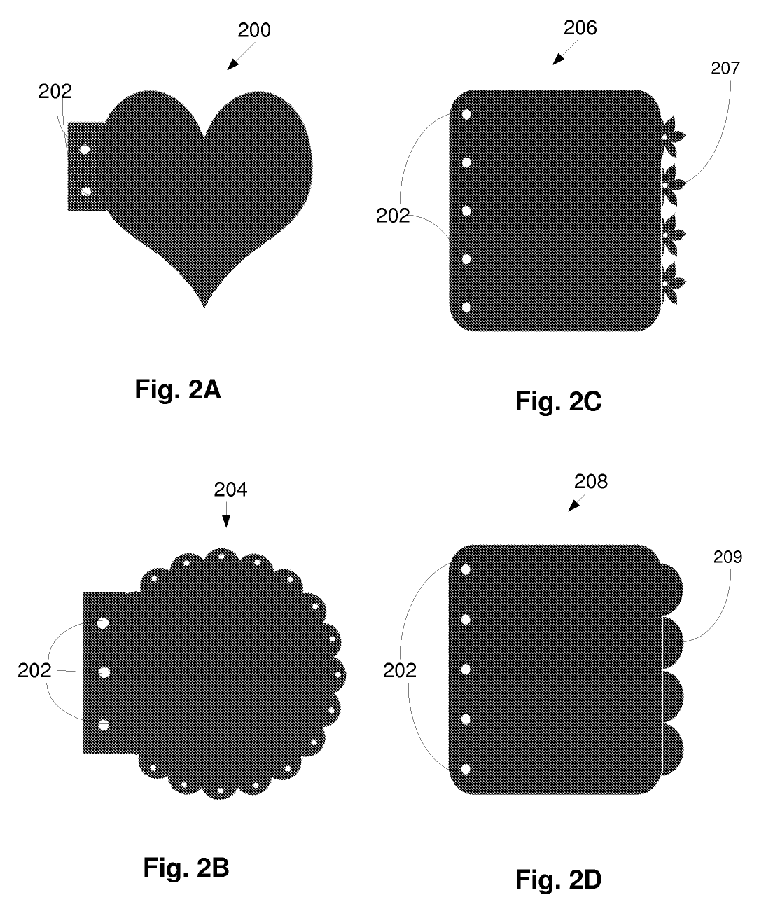

In the first preferred embodiment of the present invention as shown in FIG. 2A, a heart shaped component 200 of the present invention is shown. On one side of component 200 holes 202 are formed for affixing component 200 to other components such as shown in FIGS. 2A-2D or a cover (not shown).

In the second preferred embodiment of the present invention as shown in FIG. 2B, a scallop shaped component 204 of the present invention is shown. On one side of component 204 holes 202 are formed for affixing component 204 to other components such as shown in FIGS. 2A-2D or a cover (not shown).

In the third preferred embodiment of the present invention as shown in FIG. 2C, a rectangular-like component 206 having at least one side having first desired features 207 of the present invention is shown. On one side of component 206 holes 202 are formed for affixing component 206 to other components such as shown in FIGS. 2A-2D or a cover (not shown).

In the fourth preferred embodiment of the present invention as shown in FIG. 2D, a rectangular-like component 208 having at least one side having first desired features 209 of the present invention is shown. On one side of component 208 holes 202 are formed for affixing component 208 to other components such as shown in FIGS. 2A-2D or a cover (not shown).

A scrapbook cover having the non-traditional shapes of FIGS. 2A-2D may be used as cover for the scrapbook of the present invention. Alternatively, other non-rectangular shapes other than what is shown in FIGS. 2A-2D may be used as cover for the scrapbook of the present invention.

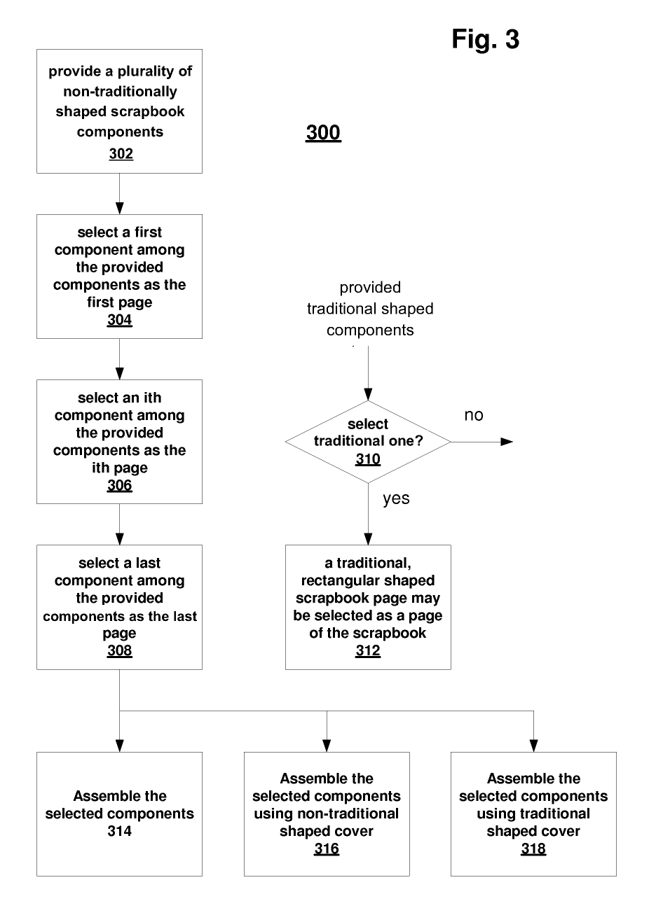

Referring to FIG. 3, an exemplified flowchart 300 in accordance with one aspect of the present invention for making a non-traditional scrapbook is shown. First, provide a plurality of non-traditionally shaped scrapbook components such as the ones shown in FIGS. 2A-2D (Step 302). Second, select a first component among the provided components as the first page (Step 304). Consequently, select ith component among the provided components as the ith page (Step 306). Where “i” is a natural number greater than one in that the ith page starts from the second page and ends before the last page. Then, select a last component among the provided components as the last page (Step 308). Alternatively, other non-traditional shapes not shown in FIGS. 2A-2D, but contemplated by the present invention may be selected as a page of the scrapbook. A determination is made as to whether to select a traditional shaped component or a non-traditional component (Step 310). If a traditional shaped component is desired, it may be selected. As a second alternative, a traditional, rectangular shaped scrapbook page may be selected as a page of the scrapbook (Step 312). Assemble the selected components by affixing them together as a finished scrapbook (Step 314). Alternatively, a non-traditional shaped cover having the affixing means may be provided for the affixing step (Step 316). A non-traditional shaped cover may include shapes shown in FIGS. 2A-2D or any other desired non-traditional shape. As a second alternative, a traditional shaped rectangular cover having the affixing means may be provided for the affixing step (Step 318).

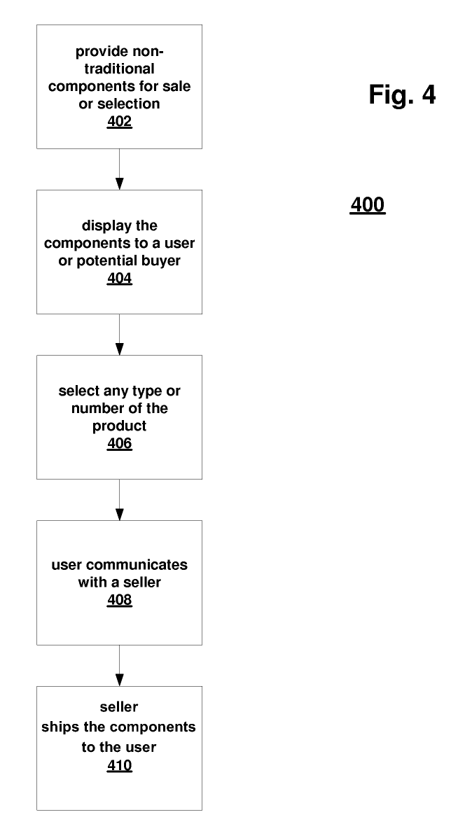

Referring to FIG. 4, an exemplified flowchart 400 in accordance with one aspect of the present invention for displaying non-traditional scrapbook components is shown. Non-traditional components or pages of a scrapbook are selected or provided for sale or selection (Step 402). The selection may be provided on a paper media such as a magazine or newspaper or any advertising paper media. Alternatively, the selection may be provided on an electronic media such as a fixed point monitor or a mobile terminal coupled to a network. The network may be a wide area network such as the Internet. The choices or selections are displayed to a user or potential buyer of the various components of the present invention (Step 404). The user may select any type or number of the products or components according to preference (Step 406). The user communicates with a seller to buy the components (Step 408). The seller, in turn, ships the component(s) to the user (Step 410).

Any known features of a scrapbook such as packet thereon for placing pictures or photos may be incorporated in the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims as issued.

1. A method comprising the step of selecting at least two non-traditional components for assembling into a scrap book. 1.

2. The method according to claim 1, further comprising the step of affixing at least two non-traditional components.

3. The method according to claim 2, wherein the step of affixing comprises of using a non-traditional binder.

4. The method according to claim 2, wherein the step of affixing comprises of using a non-traditional binder.

5. The method according to claim 1, wherein at least two non-traditional components of claim 1, comprises of non-rectangular shaped components.

6. The method according to claim 1, further comprising the step of selecting at least one traditional component.

7. The method according to claim 6, wherein at least one traditional component comprises of rectangular shaped components.

8. The method according to claim 1, wherein the non-traditional components are displayed in a media.

9. The method according to claim 8, wherein the media comprises a paper media.

10. The method according to claim 8, wherein the media comprises a electronic media.
